(19) United States
(12) Patent Application Publication
(10) Pub. No.: US 2026/0270705 A1
(43) Pub. Date: Sep. 10, 2026

(54) INTEGRATED VEHICLE WIRELESS DEVICE DETECTION AND TRUST

(71) Applicant: Ford Global Technologies, LLC, Dearborn, MI (US)

(72) Inventors: Luis Lopez, Mexico City (MX); Daniela Perez, Mexico City (MX); Viridiana Solares, Mexico City (MX)

(21) Appl. No.: 19/074,747

(22) Filed: Mar. 10, 2025

(51) Int. Cl. H04W 12/084; B60K 35/10; B60K 35/28; H04W 4/48; H04W 64/00

(52) U.S. Cl. CPC H04W 12/084; B60K 35/10; B60K 35/28; H04W 4/48; H04W 64/003

(57) ABSTRACT

A vehicle for detecting and verifying wireless devices includes a plurality of radio frequency (RF) detectors installed throughout the vehicle to scan for wireless signals; a machine learning (ML) model configured to analyze detected wireless devices and classify them as trusted or untrusted based on a database of historical usage patterns; a vehicle human machine interface (HMI), configured to display notifications regarding the detected wireless devices and receive user input to confirm whether unknown wireless devices are trusted; and an access controller configured to utilize the ML model to analyze the wireless signals from the RF detectors to determine presence and trust of wireless devices, responsive to detecting an unknown wireless device based on the ML model, provide an unknown device notification via the vehicle HMI, and update the database based on user feedback whether the unknown wireless device is trusted.

### TECHNICAL FIELD

Aspects of the disclosure relate to wireless hardware and a human machine interface (HMI) for detecting and trusting wireless devices.

### BACKGROUND

Global navigation satellite system (GNSS) trackers use various GNSS satellite networks to determine the precise location of the tracker device. These devices communicate with the satellites to provide real-time location data, which can be accessed via a smartphone app or web platform. GNSS trackers are often used for vehicles, pets, or other item that require monitoring over long distances.

Bluetooth tracker devices work by using BLUETOOTH low energy (BLE) signals to communicate with a paired smartphone or other connected device. When attached to an item, the tracker periodically broadcasts a unique identifier. This identifier may be detected by a paired phone that is within range of the tracker device. The app may display the last known location of the tracker and may also direct the tracker to emit a sound for ease of retrieval. If the tracker moves out of range, the last recorded location is stored. Some tracker devices utilize a crowdsourced network of other user devices to anonymously help locate lost items.

### SUMMARY

In one or more illustrative examples, a vehicle for detecting and verifying wireless devices includes a plurality of radio frequency (RF) detectors installed throughout the vehicle to scan for wireless signals; a machine learning (ML) model configured to analyze detected wireless devices and classify them as trusted or untrusted based on a database of historical usage patterns; a vehicle human machine interface (HMI), configured to display notifications regarding the detected wireless devices and receive user input to confirm whether unknown wireless devices are trusted; and an access controller configured to utilize the ML model to analyze the wireless signals from the RF detectors to determine presence and trust of wireless devices, responsive to detecting an unknown wireless device based on the ML model, provide an unknown device notification via the vehicle HMI, and update the database based on user feedback whether the unknown wireless device is trusted.

In one or more illustrative examples, the access controller is further configured to refrain from providing the unknown device notification via the vehicle HMI for any detected wireless devices that are trusted.

In one or more illustrative examples, the database includes wireless signal characteristics of the wireless devices in combination with information indicating which of the wireless devices are trusted.

In one or more illustrative examples, the vehicle HMI provides a vehicle illustration overlaid with detected device locations of any wireless devices that are identified by the access controller.

In one or more illustrative examples, the vehicle HMI illustrates trusted wireless devices drawn with a first appearance and illustrates untrusted wireless devices with a second appearance, wherein the first appearance is a first color or pattern, and the second appearance is a second color or pattern different from the first color or pattern.

In one or more illustrative examples, the vehicle HMI provides a key that explains the first appearance is for indicating the trusted wireless devices and the second appearance is for indicating the untrusted wireless devices.

In one or more illustrative examples, the vehicle HMI provides an option to communicate with a contact responsive to detection of the unknown wireless devices.

In one or more illustrative examples, the plurality of RF detectors includes a first RF detector located at a front driver side of the vehicle, a second RF detector located at a front passenger side of the vehicle, a third RF detector is located at a rear passenger side of the vehicle, and a fourth RF detector is located at a rear driver side of the vehicle.

In one or more illustrative examples, the plurality of RF detectors includes an additional RF detector in a center headliner of the vehicle at a different height than the other RF detectors, to enhance 3D placement detection of the detected wireless devices.

In one or more illustrative examples, the plurality of RF detectors operate on a plurality of frequency bands, including one or more global navigation satellite system (GNSS) frequency bands and/or cellular communications frequency bands, and the access controller performs signal triangulation and/or employ time-difference-of-arrival (TDOA) to locate the detected wireless devices.

In one or more illustrative examples, the vehicle HMI provides an option to manually scan the vehicle for presence of the unknown wireless devices.

In one or more illustrative examples, the vehicle HMI provides an option to automatically and periodically scan the vehicle for presence of the unknown wireless devices.

In one or more illustrative examples, a method for detecting and verifying wireless devices includes utilizing a ML model by an access controller of a vehicle to analyze wireless signals from a plurality of RF detectors installed throughout the vehicle to determine presence and trust of wireless devices, the ML model configured to analyze detected wireless devices and classify them as trusted or untrusted based on a database of historical usage patterns, the database including wireless signal characteristics of the wireless devices in combination with information indicating which of the wireless devices are trusted; responsive to detecting an unknown wireless device based on the ML model, providing an unknown device notification via a vehicle HMI, while refraining from providing the unknown device notification via the vehicle HMI for any detected wireless devices that are trusted; and updating the database based on user feedback whether the unknown wireless device is trusted.

In one or more illustrative examples, the method further includes providing, in the vehicle HMI, a vehicle illustration overlaid with detected device locations of any wireless devices that are identified by the access controller.

In one or more illustrative examples, the method further includes illustrating trusted wireless devices with a first appearance; and illustrating untrusted wireless devices with a second appearance, wherein the first appearance is a first color or pattern, and the second appearance is a second color or pattern different from the first color or pattern.

In one or more illustrative examples, the method further includes illustrating, in the vehicle HMI, a key that explains the first appearance is for indicating the trusted wireless devices and the second appearance is for indicating the untrusted wireless devices.

In one or more illustrative examples, the plurality of RF detectors operate on a plurality of frequency bands, including one or more GNSS frequency bands and/or cellular communications frequency bands, and the access controller performs signal triangulation and/or employ TDOA to locate the detected wireless devices.

In one or more illustrative examples, the method further includes one or more of providing an option in the vehicle HMI that, when selected, causes the vehicle to scan for presence of the unknown wireless devices; and providing an option in the vehicle HMI that, when selected, causes the vehicle to automatically and periodically scan the vehicle for presence of the unknown wireless devices.

In one or more illustrative examples, a non-transitory computer-readable medium includes instructions for detecting and verifying wireless devices that, when executed by one or more computing devices of a vehicle cause the vehicle to perform operations including to utilize a ML model by an access controller of a vehicle to analyze wireless signals from a plurality of RF detectors installed throughout the vehicle to determine presence and trust of wireless devices, the ML model configured to analyze detected wireless devices and classify them as trusted or untrusted based on a database of historical usage patterns, the database including wireless signal characteristics of the wireless devices in combination with information indicating which of the wireless devices are trusted; responsive to detecting an unknown wireless device based on the ML model, provide an unknown device notification via a vehicle HMI, while refraining from providing the unknown device notification via the vehicle HMI for any detected wireless devices that are trusted; and update the database based on user feedback whether the unknown wireless device is trusted.

In one or more illustrative examples, the non-transitory computer-readable medium further includes instructions that, when executed by the one or more computing devices, cause the vehicle to perform operations including to provide, in the vehicle HMI, a vehicle illustration overlaid with detected device locations of any wireless devices that are identified by the access controller; illustrate any trusted wireless devices with a first appearance; and illustrate any untrusted wireless devices with a second appearance, wherein the first appearance is a first color or pattern, and the second appearance is a second color or pattern different from the first color or pattern.

### BRIEF DESCRIPTION OF THE DRAWINGS

FIG. 1A illustrates a system including a vehicle configured for detecting and trusting wireless devices;

FIG. 1B illustrates an example overhead view of the vehicle illustrating an example placement of GNSS detectors;

FIG. 2 illustrates an example of the vehicle HMI providing for a manual scan of the vehicle for wireless devices;

FIG. 3 illustrates an example user interface provided by the vehicle HMI providing a notification of a detected wireless device;

FIG. 4 illustrates an example notification details user interface provided by the vehicle HMI responsive to selection of the view location control of the notification;

FIG. 5 illustrates an example process for the detecting and trusting of wireless devices by the vehicle; and

FIG. 6 illustrates an example computing device supporting the detecting and trusting wireless devices.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Low-frequency GNSS detectors may be installed to a vehicle to detect the approximate positioning of the GNSS devices in and around the vehicle. Based on this information, vehicle occupants or other vehicle users may be alerted of the presence of tracking devices within or attached to the vehicle. These alerts may take the form of notifications to the HMI of the vehicle, such as a center stack display screen. In an example, the HMI may include a settings section that allows the client to view approximate positioning of GNSS devices and/or an option for manual scanning of the vehicle.

Additionally, a machine learning (ML) model may be used to confirm whether device presence is expected or unexpected. This may allow for notifications to the user to decrease over time. For example, if the user always carries a personal GNSS device with them, the system may learn that this behavior is expected. For instance, if the device is historically located in the vehicle on certain days and hours of the days of the week and/or in a specific positioning inside the vehicle, then this behavior may be learned to identify whether placement of the device is typical or an outlier. Moreover, ground truth may be confirmed by the model in cases where the model is unsure if a device should be present through the use of a trust feature that, is provided to the HMI to allow the user to indicate whether an unexpected device that is detected should be present or not. For instance, a button may be presented to the HMI that, when selected, informs the model that the device is expected. Another button may be presented that may be selected if the device should not be present. Further aspects of the disclosure are discussed in detail herein.

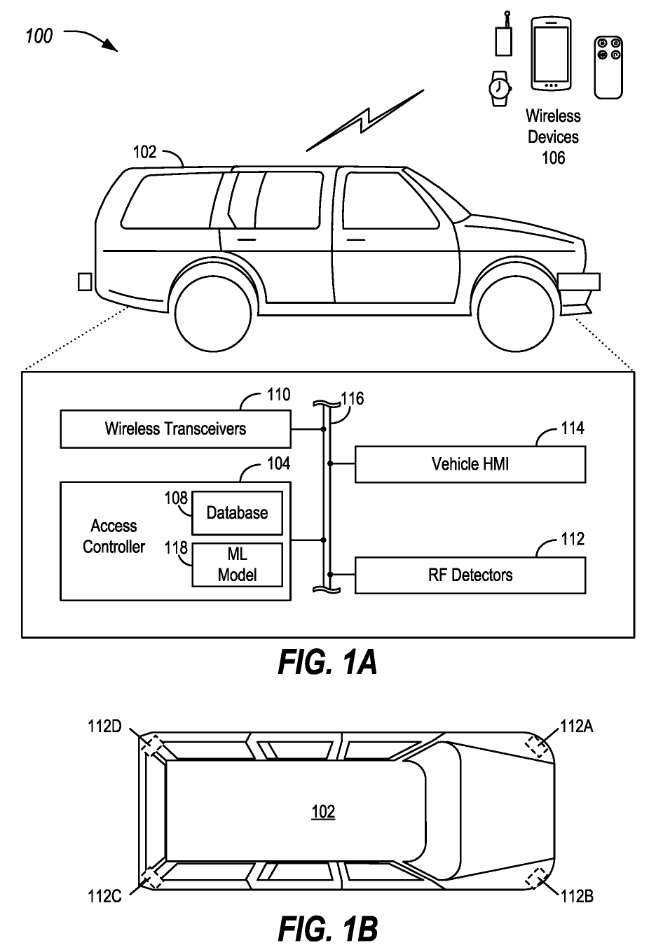

FIG. 1A illustrates a system including a vehicle configured for detecting and trusting wireless devices. The vehicle 102 may include an access controller 104. The vehicle 102 may also include or be attached to one or more wireless devices 106. The access controller 104 may be in communication with wireless transceivers 110 for communication with the wireless devices 106. The access controller 104 may also in communication with one or more radio frequency (RF) detectors 112 which may be used to identify RF transmissions independent of the paired connection of wireless devices 106 such as phones to the vehicle 102. The vehicle 102 may also include a vehicle HMI 114. The access controller 104 may utilize a ML model 118 to identify whether the detected wireless devices 106 are trusted to be present. The access controller 104 may also store a database 108 of information for use in training the operation of the ML model 118. The components of the vehicle 102 may communicate with one another over various vehicle buses 116. It should be noted that the illustrated system 100 is only an example, and systems 100 with more, fewer, or different components may be used.

The vehicle 102 may include various types of vehicle, crossover utility vehicle (CUV), sport utility vehicle (SUV), truck, recreational vehicle (RV), motorcycle, boat, trains, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle powered by one or more electric motors. As a further possibility, the vehicle 102 may be a hybrid electric vehicle powered by both an internal combustion engine and one or more electric motors, such as a plug-in hybrid electrical vehicle. Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs).

The vehicle 102 may include one or more controllers configured to perform and manage various vehicle 102 functions under the power of the vehicle battery and/or drivetrain. The controllers may include various types of computing devices in support of performance of the functions of the controllers described herein. In an example, the controllers may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, the processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, JavaScript, Perl, etc. As depicted, the example vehicle controllers are represented as discrete controllers. However, the vehicle controllers may share physical hardware, firmware, and/or software, such that the functionality from multiple controllers may be integrated into a single controller, and that the functionality of various such controllers may be distributed across a plurality of controllers.

The access controller 104 is a controller of the vehicle 102 configured to manage access control mechanisms, including user authentication, signal verification, and lock/unlock commands. The access controller 104 may include a secure processing module that ensures sensitive operations, such as cryptographic key exchange and storage, are resistant to tampering or unauthorized access. The access controller 104 may further integrate with other systems of the vehicle 102, such as an alarm system or immobilizer, to enhance security.

The wireless devices 106 may include mobile phones, wearables such as smartwatches, key fobs, or other wireless-enabled devices. In some but not all examples, the wireless devices 106 are associated with and carried by users. The wireless devices 106 may be paired with the vehicle 102 using cryptographic protocols to ensure secure data exchange and prevent unauthorized access. Pairing may occur during an initial setup process, where unique identifiers for the wireless devices 106 and/or wireless signal characteristics of the wireless devices 106 are stored to a database 108 the access controller 104. In some configurations, the wireless devices 106 may also store digital keys issued by the vehicle 102 manufacturer or owner to the database 108, enabling temporary or limited access to other users. Such temporary keys may include time-based restrictions or geofencing rules for enhanced control. Additionally, the access controller 104 may maintain a log of access events in the database 108, including the identity of wireless devices 106 and timestamps, to provide a record of vehicle 102 entry and exit.

The access controller 104 may be in communication with one or more wireless transceivers 110. The wireless transceivers 110 may include hardware and software components capable of supporting a range of wireless communication protocols, such as BLE, ultra-wideband (UWB), Wi-Fi, or Near Field Communication (NFC). These protocols enable communication between the wireless devices 106 and the access controller 104. UWB may allow for centimeter-level precision in determining the position of a wireless device 106 relative to the vehicle 102, while BLUETOOTH may facilitate a measurement of signal strength which may provide a more coarse measure of distance to a user with a lower power budget.

In some cases, the wireless devices 106 may include GNSS functionality in combination with other functionality. In some cases, the wireless devices 106 may include GNSS functionality for the specific purpose of being GNSS trackers, with or without other wireless functionality. The GNSS functionality may include one or more of global positioning system (GPS), Globalnaya Navigatsionnaya Sputnikovaya Sistema (GLONASS), Galileo, BeiDou Navigation Satellite System (BDS), etc.

As a further way to detect wireless devices 106, the access controller 104 may also be in communication with one or more RF detectors 112. Rather than for communication, the RF detectors 112 may instead be configured to detect the presence of RF signals in various frequency bands. The RF detectors 112 may operate on various frequency ranges, such as GNSS bands (e.g., 1575.42 MHz, 1227.60 MHz, 1176.45 MHz, etc.), global system for mobile communication (GSM) 2G (e.g., 900 MHz to 1.8 GHz), 3G (e.g., 1.9 GHz to 2.1 GHz), 4G/ long term evolution (LTE) (e.g., 700 MHz to 2.6 GHz), 5G (e.g., 3.5 GHz to 6 GHz), and/or Wi-Fi (e.g., 2.4 GHz to 5 GHz). Collectively, the RF detectors 112 serve to provide coverage for transmissions that may be used to identify the locations of wireless devices 106.

The array of RF detectors 112 may useful for uncovering the presence of GNSS tracking wireless devices 106 by monitoring the electromagnetic spectrum for signals indicative of covert transmitters or receivers. In a GNSS tracking setup, the wireless devices 106 receives satellite signals at specific frequencies (such as the L1, L2, and L5 bands for GPS, Galileo, and other constellations), processes location information, and then relays that data back via cellular or other wireless networks. Although GNSS receivers on their own may not usually emit strong signals, any module that transmits data, such as a cellular-enabled tracker, will produce a measurable RF footprint. Thus, the array of RF detectors 112, strategically placed, may be used to detect the faint or intermittent signals associated with these transmissions and help pinpoint the source. Using the RF detectors 112, the access controller 104 may perform signal triangulation or employ time-difference-of-arrival (TDOA) techniques to locate the wireless devices 106.

Referring to FIG. 1B, an example placement of the RF detectors 112 is shown. In this example, there are four RF detectors 112 placed at the corners of the vehicle 102. A first RF detector 112A is located at the front driver side of the vehicle 102, a second RF detector 112B is located at the front passenger side of the vehicle 102, a third RF detector 112C is located at the rear passenger side of the vehicle 102, and a fourth RF detector 112D is located at the rear driver side of the vehicle 102. It should be noted that the placement shown in FIG. 1B is only an example, and more, fewer, or differently located RF detectors 112 are possible. In an example, one or more RF detectors 112 may be located in the center headliner of the vehicle 102, e.g., at a different height than the other RF detectors 112, to further enhance placement detection of the wireless devices 106.

Returning to FIG. 1A, the vehicle HMI 114 may be configured to receive input from a user to the vehicle 102 via various buttons or other controls, as well as provide vehicle status information using one or more lights, speakers, and/or display screens to present information. This information may include, as some examples, fuel or charge level information, engine operating temperature information, and current location of the vehicle 102. The vehicle HMI 114 may be configured to provide information to various displays within the vehicle 102, such as a center stack touchscreen, a gauge cluster screen, etc.

A vehicle bus 116 may include various methods of communication available between the various components of the vehicle 102 discussed herein. As some non-limiting examples, the vehicle bus 116 may include one or more of a vehicle controller area network (CAN), an Ethernet network, a media-oriented system transfer (MOST) network, and/or a wireless network. While a single vehicle bus 116 is illustrated, it should be noted that in many examples, multiple vehicle buses 116 are included, with a subset of the controllers connected to each vehicle bus 116.

The access controller 104 may be configured to utilize the RF detectors 112 to scan for wireless devices 106. The access controller 104 may begin by scanning at a maximum level of detection and progressively going down, the RF detectors 112 that still identify a signal will repeat the process until the approximate position of the wireless devices 106 is located. With the approximate location via GNSS, metadata may be captured from the vehicle 102, such as an identify of the driver or other vehicle 102 occupants, day of the week and time of day. This information detected wireless devices 106 with the metadata may be stored to the access controller 104 in the database 108.

The access controller 104 may be configured to utilize a ML model 118 to confirm whether presence of the detected wireless devices 106 is expected or unexpected. If an unexcepted wireless device 106 is detected the vehicle HMI 114 may be used to indicate the presence and/or location of the unexpected wireless device 106. Feedback may be received from the occupants via the vehicle HMI 114. In an example, the vehicle HMI 114 may be used to receive information from the occupants of the vehicle asking if the detected wireless devices 106 are known, e.g., whether the detected wireless devices 106 were intentionally placed by the occupants of the vehicle 102. This confirmation may be performed because cell phones, pet tags, other devices may have been intentionally placed in or on the vehicle 102.

The database 108 may be fed into the ML model 118 (e.g., a classification model, a clustering model, etc.) to allow the ML model 118 to detect whether the wireless devices 106 are expected or unexpected. With the feedback from the user, the ML model 118 may be continuously updated to fit and adjust to the database 108 such that the ML model 118 is trained to only provide confirmations for unknown wireless devices 106.

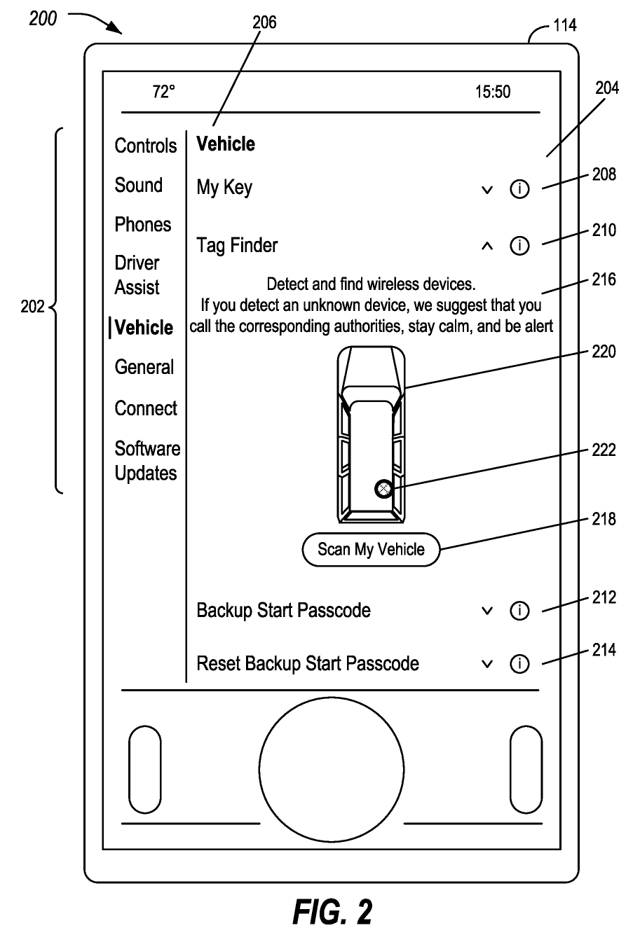

FIG. 2 illustrates an example settings user interface 200 of the vehicle HMI 114 providing for a manual scan of the vehicle 102 for wireless devices 106. The settings user interface 200 may be used to allow the user to view the locations of detected wireless devices 106. In an example, the settings user interface 200 may be provided by the vehicle HMI 114 to a display within the cabin of the vehicle 102.

The settings user interface 200 includes a settings category listing 202 of one or more screens of settings to be displayed in a main screen area 204. As some examples, the settings category listing 202 may include a controls page, a sound page, a phones page, a driver assist page, a vehicle page, a general page, a connect page, and a software updates page. As shown, the vehicle page is currently selected in the settings category listing 202 and is displayed in the main screen area 204. A title 206 is also included at the top of the main screen area 204 to indicate which of the pages from the settings category listing 202 is being shown.

The vehicle settings include sections items such as key settings section 208, a tag finder section 210, a backup start passcode section 212, and reset backup start passcode section 214. Each of these sections 208, 210, 212, and 214 may be expanded to view details of the settings or contacted to hide the details and show more available sections. In the example settings user interface 200 as shown, the tag finder section 210 is expanded, and the other sections are not expanded.

The expanded tag finder section 210 includes various items to facilitate the identification of the wireless devices 106. The tag finder section 210 may include a description 216 that indicates that the purpose of the tag finder section 210 is to allow the user to detect and find devices. The description 216 may further indicate to the user to stay calm or other helpful information.

The tag finder section 210 may also include a scan my vehicle control 218 that, when selected by the user, causes the access controller 104 to utilize the RF detectors 112 to scan for wireless devices 106. The tag finder section 210 also includes a vehicle illustration 220 which may be overlaid with detected device locations 222 of any wireless devices 106 that are identified by the access controller 104. By showing the detected device locations 222 in the context of the vehicle 102, a user may easily locate the detected wireless devices 106 by checking the indicated location on the vehicle illustration 220.

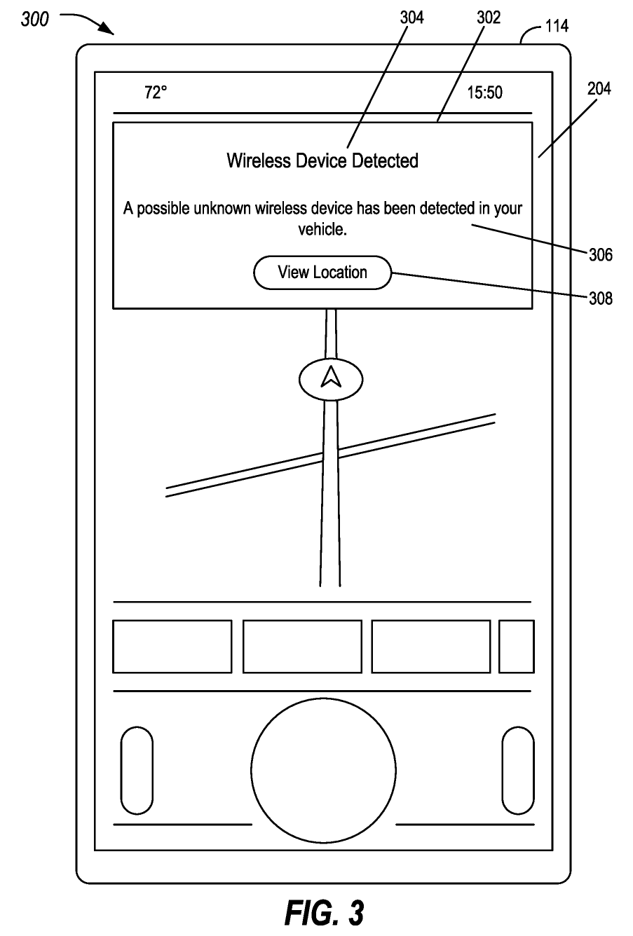

FIG. 3 illustrates an example user interface 300 provided by the vehicle HMI 114 providing an unknown device notification 302 of a detected wireless device 106. The unknown device notification 302 may be generated responsive to a periodic polling of the RF detectors 112 by the access controller 104 to scan for wireless devices 106. As shown, the unknown device notification 302 is overlaid on the main screen area 204 of the vehicle HMI 114, e.g., in this case over a navigation screen.

The unknown device notification 302 includes a title 304 indicating that a wireless device 106 has been detected. The unknown device notification 302 may also include a notification description 306 explaining that a possible unknown wireless device 106 has been detected in the vehicle 102. The unknown device notification 302 may also include a view location control 308 that, when selected by the user, allows the user to view the location of the detected wireless device 106 the context of the vehicle 102 (e.g., similar to as shown the settings user interface 200).

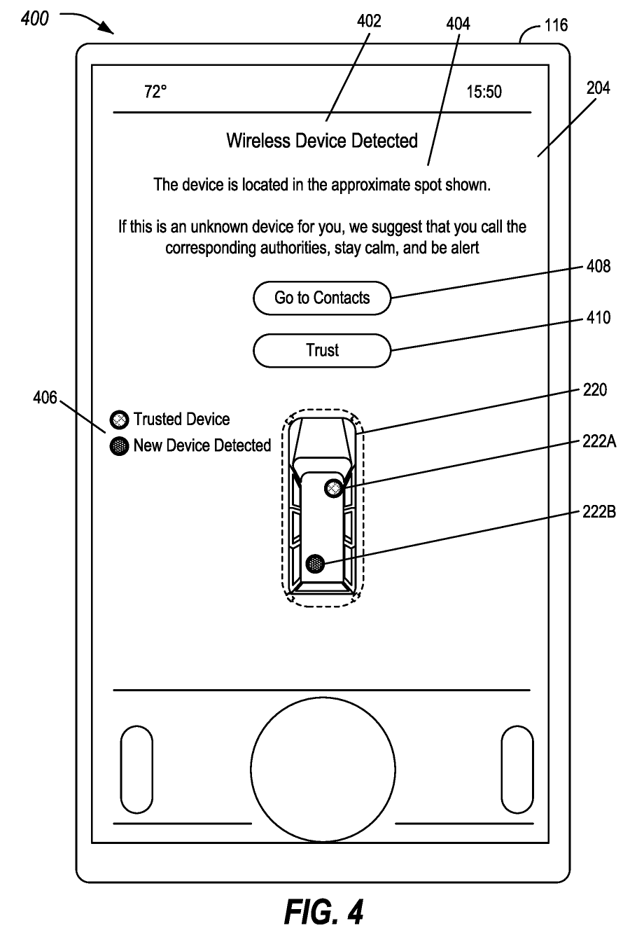

FIG. 4 illustrates an example notification details user interface 400 provided by the vehicle HMI 114 responsive to selection of the view location control 308 of the unknown device notification 302. As shown, the unknown device notification 302 is replaced by content utilizing the main screen area 204.

The notification details user interface 400 includes a title 402 indicating that a wireless device 106 has been detected. The notification details user interface 400 may also include a notification description 404 explaining that a possible unknown wireless device 106 has been detected in the vehicle 102, and further that the wireless device 106 is shown as a detected device location 222 overlaid on the vehicle illustration 220.

In this example, there are two detected wireless devices 106, shown at detected device locations 222A and 222B. In an example, the vehicle HMI 114 illustrates the trusted wireless devices 106 as drawn with a first appearance, and illustrates the untrusted wireless devices 106 as drawn with a second, different appearance. The notification details user interface 400 may also include a key 406 that indicates the first appearance for trusted devices and the second appearance for untrusted (e.g., new) devices are shown. The key 406 explains that the first appearance is for indicating the trusted wireless devices 106 and the second appearance is for indicating the untrusted wireless devices 106. In an example, the first appearance is a first color or pattern, and the second appearance is a second color or pattern different from the first color or pattern. Using the key 406 and the detected device locations 222 shown on the vehicle illustration 220, the user can understand not only where wireless devices 106 are detected, but also which wireless devices 106 the ML model 118 understands to be trusted based on the database 108.

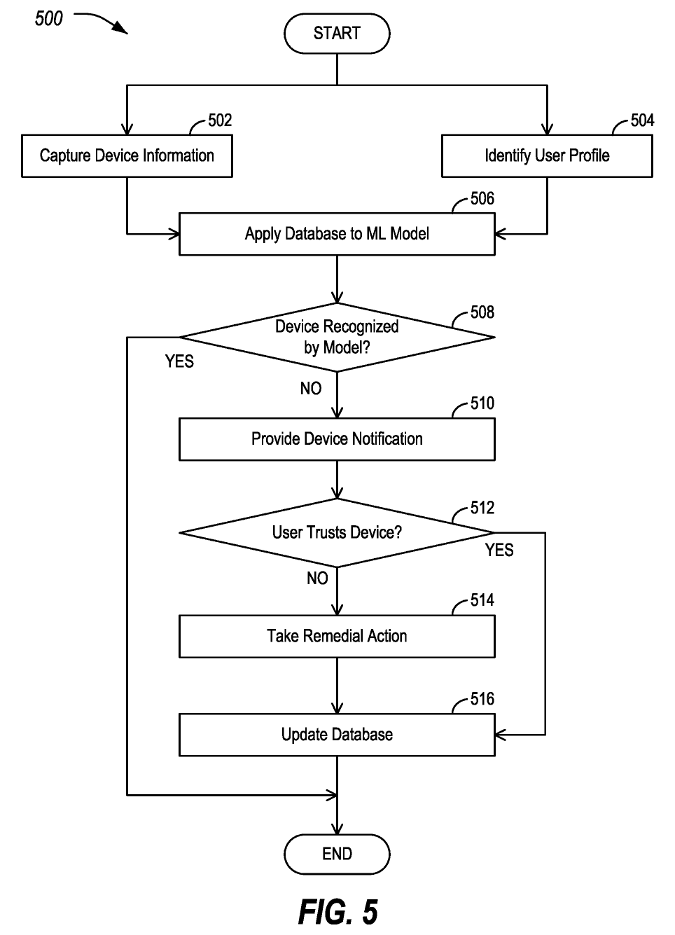

FIG. 5 illustrates an example process 500 for the detecting and trusting of wireless devices 106 by the vehicle 102. In an example, the process 500 may be performed by the access controller 104 of the vehicle 102 in the context of the system 100 discussed above.

At operation 502, the access controller 104 captures information about wireless devices 106. This may involve scanning for active wireless signals using RF detectors 112 positioned around the vehicle 102. The access controller 104 may collect metadata such as signal strength, frequency band, transmission patterns, and approximate location within the vehicle. If multiple wireless devices 106 are detected, the access controller 104 may cross-reference their identifiers with previously stored information in the database 108 to determine if any of the detected devices match known profiles.

At operation 504, the access controller 104 identifies a user profile of an occupant of the vehicle 102. This can involve analyzing vehicle 102 login credentials, biometric authentication (such as fingerprint or facial recognition), or proximity-based authentication using paired mobile devices. The user profile may include historical data about previously trusted wireless devices 106, travel patterns, and personal preferences regarding alert sensitivity. Additionally, the access controller 104 may correlate user profiles with vehicle location occupancy sensors to determine which users are actively present in the vehicle 102 at a given time.

At operation 506, the access controller 104 applies the database 108 to the ML model 118. The ML model 118 may process data using classification algorithms to differentiate between recognized and unrecognized wireless devices 106. This step involves feature extraction, where device metadata is compared against historical trends. For example, the model may evaluate whether a device has been detected in similar locations at similar times before, and whether its behavior aligns with expected user habits. If a device exhibits anomalous patterns, it may be flagged for further review.

At operation 508, the access controller 104 determines whether any detected wireless devices 106 are recognized as trusted by the ML model 118. If so, the process 500 ends. Otherwise, the process continues to operation 510, where the detected wireless device 106 is flagged as potentially untrusted, prompting user intervention.

At operation 510, the access controller 104 provides an unknown device notification 302 to the vehicle HMI 114. This notification may include details about the detected wireless device 106, such as its approximate location within the vehicle, signal strength, and duration of detection. The notification may also offer options, such as “View Location,” “Mark as Trusted,” or “Report Suspicious Device.” If the device is detected while the vehicle 102 is in motion, the notification may be delayed or otherwise presented in an appropriate manner.

At operation 512, the access controller 104 determines whether the user trusts the wireless device 106. For example, the user may mark the detected wireless device 106 as trusted. Or, the user may mark the detected wireless device 106 as untrusted or may not mark it as trusted. If the device is not trusted, control passes to operation 514. If the user does trust the device, control proceeds to operation 516.

At operation 514, the access controller 104 takes remedial action. In an example, the user may select to go to the contacts and call for help. In another example, the access controller 104 may initiate security protocols such as activating the vehicle’s alarm system, notifying vehicle security services, or providing guidance on physical inspection of the detected wireless device 106. The remedial action may also include a mapping feature that shows nearby law enforcement or security assistance locations that the user can navigate to for further assistance. Additionally, the access controller 104 may provide an option for users to disable the detected wireless device 106 if it is interfering with vehicle functions or suspected of unauthorized tracking.

At operation 516, the access controller 104 updates the database 108. The update may include storing the user’s response regarding whether the detected wireless device 106 is trusted or untrusted. If the user has marked the device as trusted, the database 108 will store metadata associated with the device, including its frequency of detection, positioning, and association with specific users or time frames. If the device is marked as untrusted, the access controller 104 may flag it for enhanced tracking and future alerts. The database 108 may also incorporate feedback from multiple users of the vehicle 102 to refine the ML model 118 and enhance its predictive accuracy in distinguishing between expected and unexpected wireless devices 106. Additionally, the ML model 118 may be retrained periodically based on aggregated user interactions and detections to continuously enhance its performance. After operation 516, the process 500 ends.

Thus, the process 500 is structured to provide a balance between security and user convenience. By leveraging historical data and user feedback, the system reduces unnecessary alerts while maintaining a robust security protocol for detecting unauthorized tracking devices. The iterative learning of the ML model 118 ensures that over time, the access controller 104 can distinguish between benign and potentially malicious wireless devices 106 with greater accuracy. Further, the ability to provide real-time alerts and remedial actions enhances the privacy of vehicle occupants by mitigating potentials associated with unauthorized tracking.

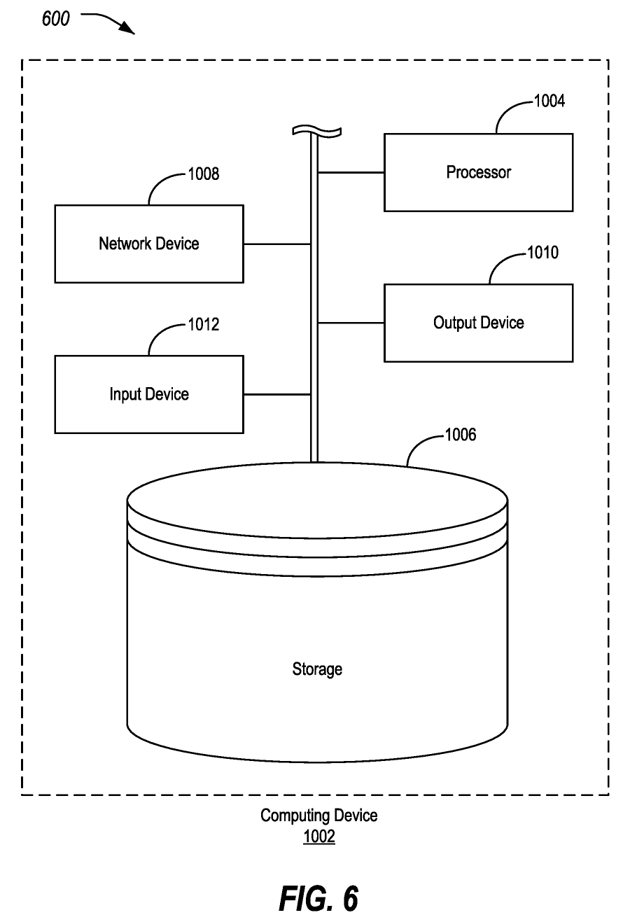

FIG. 6 illustrates an example computing device supporting the detecting and trusting wireless devices 106. Referring to FIG. 6, and with reference to FIGS. 1A-6, the vehicles 102, access controller 104, wireless devices 106, wireless transceivers 110, vehicle HMI 114, etc., may be examples of such computing devices 602. Computing devices 602 generally include computer-executable instructions, where the instructions may be executable by one or more computing devices 602. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the database 108 and the ML model 118, may be stored and transmitted using a variety of computer-readable media.

As shown, the computing device 602 may include a processor 604 that is operatively connected to a storage 606, a network device 608, an output device 610, and an input device 612. It should be noted that this is merely an example, and computing devices 602 with more, fewer, or different components may be used.

The processor 604 may include one or more integrated circuits that implement the functionality of a central processing unit (CPU) and/or graphics processing unit (GPU). In some examples, the processors 604 are a system on a chip (SoC) that integrates the functionality of the CPU and GPU. The SoC may optionally include other components such as, for example, the storage 606 and the network device 608 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 604 executes stored program instructions that are retrieved from the storage 606. The stored program instructions, accordingly, include software that controls the operation of the processors 604 to perform the operations described herein. The storage 606 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 610. The output device 610 may include a graphical or visual display device, such as an electronic display screen, projector, printer, or any other suitable device that reproduces a graphical display. As another example, the output device 610 may include an audio device, such as a loudspeaker or headphone. As yet a further example, the output device 610 may include a tactile device, such as a mechanically raiseable device that may, in an example, be configured to display braille or another physical output that may be touched to provide information to a user.

The input device 612 may include any of various devices that enable the computing device 602 to receive control input from users. Examples of suitable input devices 612 that receive human interface inputs may include keyboards, mice, trackballs, touchscreens, microphones, graphics tablets, and the like.

The network devices 608 may each include any of various devices that enable the described components to send and/or receive data from external devices over networks. Examples of suitable network devices 608 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as "a," "the," "said," etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle for detecting and verifying wireless devices, comprising:
a plurality of radio frequency (RF) detectors installed throughout the vehicle to scan for wireless signals;
a machine learning (ML) model configured to analyze detected wireless devices and classify them as trusted or untrusted based on a database of historical usage patterns;
a vehicle human machine interface (HMI), configured to display notifications regarding the detected wireless devices and receive user input to confirm whether unknown wireless devices are trusted; and
an access controller configured to:
utilize the ML model to analyze the wireless signals from the RF detectors to determine presence and trust of wireless devices,
responsive to detecting an unknown wireless device based on the ML model, provide an unknown device notification via the vehicle HMI, and
update the database based on user feedback whether the unknown wireless device is trusted.

2. The vehicle of claim 1, wherein the access controller is further configured to refrain from providing the unknown device notification via the vehicle HMI for any detected wireless devices that are trusted.

3. The vehicle of claim 1, wherein the database includes wireless signal characteristics of the wireless devices in combination with information indicating which of the wireless devices are trusted.

4. The vehicle of claim 1, wherein the vehicle HMI provides a vehicle illustration overlaid with detected device locations of any wireless devices that are identified by the access controller.

5. The vehicle of claim 1, wherein the vehicle HMI illustrates trusted wireless devices drawn with a first appearance and illustrates untrusted wireless devices with a second appearance, wherein the first appearance is a first color or pattern, and the second appearance is a second color or pattern different from the first color or pattern.

6. The vehicle of claim 5, wherein the vehicle HMI provides a key that explains the first appearance is for indicating the trusted wireless devices and the second appearance is for indicating the untrusted wireless devices.

7. The vehicle of claim 1, wherein the vehicle HMI provides an option to communicate with a contact responsive to detection of the unknown wireless devices.

8. The vehicle of claim 1, wherein the plurality of RF detectors includes a first RF detector located at a front driver side of the vehicle, a second RF detector located at a front passenger side of the vehicle, a third RF detector is located at a rear passenger side of the vehicle, and a fourth RF detector is located at a rear driver side of the vehicle.

9. The vehicle of claim 8, wherein the plurality of RF detectors includes an additional RF detector in a center headliner of the vehicle at a different height than the other RF detectors, to enhance 3D placement detection of the detected wireless devices.

10. The vehicle of claim 1, wherein the plurality of RF detectors operate on a plurality of frequency bands, including one or more global navigation satellite system (GNSS) frequency bands and/or cellular communications frequency bands, and the access controller performs signal triangulation and/or employ time-difference-of-arrival (TDOA) to locate the detected wireless devices.

11. The vehicle of claim 1, wherein the vehicle HMI provides an option to manually scan the vehicle for presence of the unknown wireless devices.

12. The vehicle of claim 1, wherein the vehicle HMI provides an option to automatically and periodically scan the vehicle for presence of the unknown wireless devices.

13. A method for detecting and verifying wireless devices, comprising:
utilizing a ML model by an access controller of a vehicle to analyze wireless signals from a plurality of RF detectors installed throughout the vehicle to determine presence and trust of wireless devices, the ML model configured to analyze detected wireless devices and classify them as trusted or untrusted based on a database of historical usage patterns, the database including wireless signal characteristics of the wireless devices in combination with information indicating which of the wireless devices are trusted;
responsive to detecting an unknown wireless device based on the ML model, providing an unknown device notification via a vehicle HMI, while refraining from providing the unknown device notification via the vehicle HMI for any detected wireless devices that are trusted; and
updating the database based on user feedback whether the unknown wireless device is trusted.

14. The method of claim 13, further comprising providing, in the vehicle HMI, a vehicle illustration overlaid with detected device locations of any wireless devices that are identified by the access controller.

15. The method of claim 14, further comprising:
illustrating trusted wireless devices with a first appearance; and
illustrating untrusted wireless devices with a second appearance,
wherein the first appearance is a first color or pattern, and the second appearance is a second color or pattern different from the first color or pattern.

16. The method of claim 15, further comprising illustrating, in the vehicle HMI, a key that explains the first appearance is for indicating the trusted wireless devices and the second appearance is for indicating the untrusted wireless devices.

17. The method of claim 13, wherein the plurality of RF detectors operate on a plurality of frequency bands, including one or more GNSS frequency bands and/or cellular communications frequency bands, and the access controller performs signal triangulation and/or employ TDOA to locate the detected wireless devices.

18. The method of claim 13, further comprising one or more of:
providing an option in the vehicle HMI that, when selected, causes the vehicle to scan for presence of the unknown wireless devices; and
providing an option in the vehicle HMI that, when selected, causes the vehicle to automatically and periodically scan the vehicle for presence of the unknown wireless devices.

19. A non-transitory computer-readable medium comprising instructions for detecting and verifying wireless devices that, when executed by one or more computing devices of a vehicle cause the vehicle to perform operations including to:
utilize a ML model by an access controller of a vehicle to analyze wireless signals from a plurality of RF detectors installed throughout the vehicle to determine presence and trust of wireless devices, the ML model configured to analyze detected wireless devices and classify them as trusted or untrusted based on a database of historical usage patterns, the database including wireless signal characteristics of the wireless devices in combination with information indicating which of the wireless devices are trusted;
responsive to detecting an unknown wireless device based on the ML model, provide an unknown device notification via a vehicle HMI, while refraining from providing the unknown device notification via the vehicle HMI for any detected wireless devices that are trusted; and
update the database based on user feedback whether the unknown wireless device is trusted.

20. The non-transitory computer-readable medium of claim 19, further comprising instructions that, when executed by the one or more computing devices, cause the vehicle to perform operations including to:
provide, in the vehicle HMI, a vehicle illustration overlaid with detected device locations of any wireless devices that are identified by the access controller;
illustrate any trusted wireless devices with a first appearance; and
illustrate any untrusted wireless devices with a second appearance,
wherein the first appearance is a first color or pattern, and the second appearance is a second color or pattern different from the first color or pattern.
